(19) United States
(12) Patent Application Publication
(10) Pub. No.: US 2026/0304057 A1
(43) Pub. Date: Oct. 1, 2026

(54) METHODS AND SYSTEMS FOR MANAGING AUDIO IN MULTI-USER ENVIRONMENT

(71) Applicant: Varjo Technologies Oy, Helsinki (FI)

(72) Inventors: Oliver Merilaid, Helsinki (FI); Teemu Ikonen, Espoo (FI); Kai Inha, Järvenpää (FI)

(73) Assignee: Varjo Technologies Oy, Helsinki (FI)

(21) Appl. No.: 19/095,210

(22) Filed: Mar. 31, 2025

(51) Int. Cl. H04S 7/00

(52) U.S. Cl. CPC H04S 7/301; H04S 2400/13; H04S 2400/15

(57) ABSTRACT

A system and a method for managing audio interference between audio devices operating within a physical environment. The method includes capturing respective audio signals from the physical environment using audio sensors associated with a plurality of audio devices; analysing the audio signals to determine whether at least two audio devices from the plurality of audio devices are within an audio interference range; detecting a first audio signal from a first user associated with a first audio device determined to be within the audio interference range; determining whether playback of the first audio signal through a second audio device would create an audio interference condition for the first user; and when it is determined that the playback would create the audio interference condition, modifying one or more audio playback parameters of the second audio device to mitigate the audio interference condition.

### TECHNICAL FIELD

The present disclosure relates to methods for managing audio interference between audio devices operating within a physical environment. Moreover, the present disclosure relates to systems for managing audio interference between audio devices operating within a physical environment.

### BACKGROUND

Audio communication systems have become increasingly sophisticated and are being widely used in various applications including virtual reality (VR), augmented reality (AR), and mixed reality (XR) environments. These audio communication systems typically employ multiple audio devices, such as head-mounted devices equipped with speakers and microphones, to enable users to communicate with both local and remote participants. The audio devices are configured to capture and playback audio signals, thereby facilitating real-time communication between users present in a physical environment as well as with remote participants.

However, when multiple audio devices are operated within the same physical environment, several technical challenges arise that significantly impact the quality of audio communication. A primary challenge occurs when multiple users wearing audio devices are physically present in close proximity to each other, leading to interference between direct acoustic transmission of speech and electronic playback through the audio devices. This interference manifests in two distinct problems. Firstly, users may experience their own voice being played back through nearby users'devices with a delay, creating a delayed auditory feedback effect. Secondly, when remote participants'audio is played through multiple local devices, users may hear the same audio multiple times with varying delays, creating echo effects and degrading speech intelligibility.

Conventional approaches to address these challenges have been limited and largely ineffective. Traditional solutions typically rely on using centralized speakerphone systems, which restrict user mobility and fail to provide personalized audio experiences. Some systems attempt to solve these issues by implementing basic echo cancellation and noise reduction techniques. However, these solutions do not adequately address the specific challenges posed by modern audio devices, particularly those with open-ear speaker designs commonly used in VR/XR headsets, where audio leakage between devices is more pronounced.

The limitations of existing solutions become particularly apparent in scenarios involving open-ear speaker designs, which are increasingly popular in modern head-mounted devices. These speakers, while providing improved situational awareness and comfort, exacerbate the audio interference issues due to their inherent issue of audio leakage. The delayed auditory feedback caused by such interference can lead to speech disruption, causing users to experience difficulties in maintaining normal conversation flow. Moreover, existing solutions fail to provide dynamic adaptation mechanisms that can account for varying user proximities and different types of audio devices being used simultaneously in the same physical space.

Therefore, in light of the foregoing discussion, there exists a need to overcome the aforementioned drawbacks associated with managing audio interference between multiple audio devices operating within a physical environment.

### SUMMARY

The aim of the present disclosure is to provide a method and a system to manage audio interference between audio devices operating within a physical environment. The aim of the disclosure is achieved by a method and a system for managing audio interference between audio devices operating within a physical environment as defined in the appended independent claims to which reference is made to, by capturing audio signals from the physical environment using audio sensors associated with audio devices, analysing the audio signals to detect overlapping audio patterns, determining proximity between audio devices based on the detected overlapping audio patterns, and modifying audio playback parameters when audio interference conditions are detected. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is a block diagram of a system for managing audio interference between audio devices operating within a physical environment, in accordance with an embodiment of the present disclosure; and

FIG. 2 is a flowchart illustrating steps of a method for managing audio interference between audio devices operating within a physical environment, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a method for managing audio interference between audio devices operating within a physical environment, the method comprising:
capturing respective audio signals from the physical environment using audio sensors associated with a plurality of audio devices;
analysing the audio signals to determine whether at least two audio devices from the plurality of audio devices are within an audio interference range by:
   detecting overlapping audio patterns in the captured audio signals, and
   determining proximity between the at least two audio devices based on the detected overlapping audio patterns;
detecting a first audio signal from a first user associated with a first audio device from the at least two audio devices determined to be within the audio interference range;
determining whether playback of the first audio signal through a second audio device from the at least two audio devices would create an audio interference condition for the first user based on the determined proximity; and
when it is determined that the playback would create the audio interference condition, modifying one or more audio playback parameters of the second audio device to mitigate the audio interference condition.

The method for managing audio interference between audio devices enables detection and mitigation of interference conditions through multi-stage analysis of audio signals. The detection of overlapping audio patterns in captured audio signals provides proximity determination between audio devices without requiring additional positioning hardware. The method ensures clear audio communication by analysing potential interference between direct acoustic transmission and electronic playback paths. The automatic modification of audio playback parameters based on detected interference conditions prevents delayed auditory feedback effects that can disrupt speech production. The present method maintains natural communication flow between users while preventing audio artifacts that commonly occur when multiple audio devices operate in close proximity within the physical environment.

In a second aspect, the present disclosure provides a system for managing audio interference between audio devices operating within a physical environment, the system comprising:
a first audio device having a first audio sensor;
a second audio device having a second audio sensor;
a processing unit communicatively coupled to the first audio device and the second audio device, wherein the processing unit is configured to:
receive respective audio signals captured from the physical environment using the first and second audio sensors;
analyse the captured audio signals to determine whether the first audio device and the second audio device are within an audio interference range by:
   detecting overlapping audio patterns in the captured audio signals, and
   determining proximity between the first audio device and the second audio device based on the detected overlapping audio patterns;
detect a first audio signal from a first user associated with the first audio device when determined to be within the audio interference range;
determine whether playback of the first audio signal through the second audio device would create an audio interference condition for the first user based on the determined proximity; and
when it is determined that the playback would create the audio interference condition, modify one or more audio playback parameters of the second audio device to mitigate the audio interference condition.

The system for managing audio interference between audio devices implements hardware components and processing capabilities for real-time interference management. The first audio device and the second audio device incorporate audio sensors that enable continuous monitoring of the physical environment, while the processing unit provides analysis and control capabilities. The system enables automatic detection of interference conditions through analysis of captured audio signals without requiring manual configuration or user intervention. The modification of audio playback parameters by the processing unit ensures optimal audio delivery across multiple audio devices while preventing interference between direct acoustic transmission and electronic playback paths. The system maintains audio quality across different physical configurations through dynamic adjustment of playback parameters based on detected proximity between audio devices.

The method involves utilizing audio sensors associated with audio devices to monitor and manage audio interference within the physical environment. Throughout the present disclosure, the term “physical environment” refers to any space where multiple audio devices are operated simultaneously, such as conference rooms, office spaces, virtual reality gaming areas, or similar collaborative spaces. The audio devices may include head-mounted devices, portable communication devices, smart speakers, or any other devices capable of audio capture and playback.

The audio sensors associated with the audio devices are configured to capture audio signals from the physical environment. The audio sensors may be implemented as microphones, acoustic sensors, or similar transducers capable of converting acoustic waves into electrical signals. Each audio sensor is configured to capture various types of audio signals including direct speech, ambient sounds, and audio playback from other devices within the physical environment. The captured audio signals comprise information about amplitude, frequency, and temporal characteristics of the sounds present in the physical environment.

The method further involves analysing the captured audio signals to determine whether at least two audio devices from the plurality of audio devices are within the audio interference range. The term “audio interference range” refers to a physical proximity between audio devices where audio signals from one device can potentially interfere with audio playback or reception at another device. This analysis involves sophisticated signal processing techniques to detect and evaluate potential interference conditions.

Herein, determining the audio interference range involves detecting overlapping audio patterns in the captured audio signals. The overlapping audio patterns may be in the form of similar acoustic signatures captured by different audio sensors, indicating that the audio devices are capturing the same sound sources. The detection of overlapping patterns involves analysing various characteristics of the captured audio signals including frequency content, temporal alignment, and amplitude relationships.

Further, determining the proximity between the at least two audio devices is performed based on the detected overlapping audio patterns. The method employs signal processing algorithms to analyse characteristics of the overlapping patterns such as signal strength, time delay between captures, and correlation between audio signals. Multiple parameters of the captured signals are evaluated to accurately determine the relative positions of the audio devices.

The method further involves detecting the first audio signal from the first user associated with the first audio device from the at least two audio devices determined to be within the audio interference range. This detection involves identifying specific audio patterns corresponding to user speech or other user-generated sounds. The first audio signal is analysed to extract characteristics such as voice patterns, speech onset timing, and acoustic properties that distinguish it from other ambient sounds or audio playback.

The method further involves determining whether playback of the first audio signal through the second audio device would create an audio interference condition for the first user. This determination is based on the previously determined proximity between the devices and involves analysing potential acoustic interactions between direct sound transmission and electronic playback. The audio interference condition specifically includes scenarios where a user hears their own speech both directly through acoustic transmission and with a delay through electronic playback from another user's audio device, causing delayed auditory feedback effects. The audio interference condition may arise when the same audio content reaches the user through multiple paths with different delays.

When it is determined that the playback would create the audio interference condition, the method implements corrective measures by modifying one or more audio playback parameters of the second audio device. The modification of audio playback parameters serves to mitigate the audio interference condition and maintain audio quality for all users. This modification applies to the audio signals rather than specifically to the playback device itself, enabling selective adjustment of particular audio content while preserving other audio streams. These modifications are performed in real-time to ensure continuous and effective interference management.

The method provides a comprehensive approach to audio interference management by implementing a multi-stage analysis and mitigation process. Initially, the audio sensors of the audio devices continuously monitor the physical environment to capture audio signals, including both direct acoustic transmission and electronic playback components. These captured signals undergo preliminary processing to extract key acoustic features such as frequency components, amplitude variations, and temporal characteristics. The extracted features are then analysed using digital signal processing techniques to identify potential interference patterns between different audio devices. When multiple audio devices capture similar acoustic patterns within a specific timeframe, the method initiates a detailed proximity analysis to quantify the potential for audio interference between these devices. This analysis takes into account factors such as signal strength decay over distance, acoustic wave propagation characteristics, and temporal relationships between captured signals to establish precise spatial relationships between the audio devices.

The method implements a decision-making framework that evaluates multiple factors to determine appropriate interference mitigation techniques. Herein, the method first involves analysing the temporal relationship between direct acoustic transmission and potential electronic playback paths for audio signals. This analysis considers the speed of sound in the physical environment, electronic signal processing delays, and network transmission latencies to predict potential interference patterns. The method then includes evaluating the impact of these interference patterns, considering factors such as the precedence effect, temporal masking, and spatial release from masking. Based on this analysis, the method determines whether audio playback modifications are necessary and selects appropriate modification parameters. These parameters are continuously adjusted based on real-time monitoring of the acoustic environment and changes in device positions or user behaviour, ensuring optimal audio quality is maintained throughout the operation of the audio devices.

Optionally, analysing the captured audio signals to determine whether the at least two audio devices are within the audio interference range further comprises:
computing a cross-correlation between the audio signals captured by the at least two audio devices; and
determining that the at least two audio devices are within the audio interference range when the computed cross-correlation exceeds a predetermined threshold.

That is, the method employs cross-correlation techniques for analysing the captured audio signals to determine whether the at least two audio devices are within the audio interference range. The cross-correlation analysis involves computing a correlation function between audio signals captured by different audio sensors to identify temporal and spatial relationships between the signals. Specifically, the method involves calculating a cross-correlation coefficient that quantifies the similarity between audio signals captured by different devices over a specified time window. The calculation process involves normalizing the audio signals to account for variations in amplitude and applying a sliding window analysis to track temporal alignments between the signals. The computed cross-correlation values are then compared against predetermined threshold values that are established based on empirical analysis of interference conditions. These threshold values are calibrated to account for various environmental factors such as room acoustics, background noise levels, and typical usage patterns of the audio devices. Such cross-correlation analysis provides a framework for detecting acoustic patterns that indicate device proximity even in complex acoustic environments with multiple sound sources and reflections.

The technical effect of computing cross-correlation between the audio signals and determining audio interference range based on the computed cross-correlation provides accurate detection of spatial relationships between audio devices through analysis of temporal alignment in captured audio signals. Cross-correlation analysis enables detection of acoustic patterns that indicate device proximity even in complex acoustic environments.

Optionally, analysing the captured audio signals to determine whether at least two audio devices are within the audio interference range further comprises:
detecting ambient audio patterns in the captured audio signals; and
comparing the detected ambient audio patterns to determine whether the at least two audio devices are within the audio interference range.

The analysis of ambient audio patterns provides an additional layer for accurately determining spatial relationships between audio devices. The method employs pattern recognition algorithms to identify and characterize ambient sounds present in the physical environment, such as air conditioning noise, footsteps, or other background sounds that are typically consistent across a given space. These ambient patterns serve as acoustic signatures of the physical environment, providing valuable context for determining device proximity. The method processes the captured ambient audio using spectral analysis techniques to extract characteristic features that remain stable over time. The extracted features are then compared across different audio devices to establish whether they are capturing the same ambient environment.

The technical effect of detecting and comparing ambient audio patterns enables validation of device proximity through analysis of steady-state environmental sounds. The ambient pattern analysis provides an additional layer for validating proximity between audio devices, even when direct user speech may not be present.

Herein, the determination of audio interference conditions involves analysing multiple acoustic parameters from the physical environment. The method measures Sound Pressure Level (SPL) of direct acoustic speech captured through the audio sensors when open-ear speakers are used in the audio devices. The SPL measurements are combined with audio device configuration parameters including headphone type classification, in which the headphone type may be classified as closed-back headphones, active noise cancellation headphones, or open-ear speakers. Further, herein, electronic playback parameters are analysed, including signal level, amplifier gain values, speaker sensitivity specifications, and digital signal processing settings of the audio devices. A ratio is computed between the SPL of direct acoustic speech and the SPL of electronic playback through the audio devices. When closed-back headphones are used in the audio devices, the method applies acoustic attenuation factors to account for reduced direct sound transmission. When open-ear speakers are used in the audio devices, the method measures direct acoustic sound levels using the audio sensors and calculates expected playback levels based on the electronic playback parameters.

Optionally, determining whether the at least two audio devices are within the audio interference range further comprises:
obtaining network identification information from each audio device; and
analysing the network identification information to determine proximity between the at least two audio devices.

The method may utilize such network-based positioning techniques along with acoustic-based proximity detection by analysing various types of network identification data available from the audio devices. This network identification information may include wireless network signal strengths, network addresses (like IP addresses), connection timestamps, and routing information that can indicate physical co-location of devices. The method may additionally utilize Bluetooth Low Energy (BLE) signals for proximity detection between audio devices. The BLE signals are analysed to determine Received Signal Strength Indicator (RSSI) values and connection quality metrics between audio devices. It may be appreciated that the method is compatible with other wireless communication protocols and proximity detection technologies that enable determination of spatial relationships between audio devices, without any limitations. The method processes this network information using positioning algorithms that consider factors such as signal strength decay models, network topology, and historical connection patterns to establish reliable proximity estimations between audio devices operating within the same network infrastructure.

The technical effect of analyzing network identification information for proximity determination provides a further layer for validating spatial relationships between audio devices. The network-based proximity detection enables interference range determination even in scenarios where acoustic analysis may not be possible. The network-based proximity detection further reduces computational requirements by eliminating cross-correlation calculation between audio devices that are clearly located at different sites based on network identification data. The pre-filtering of audio devices through network identification enables optimization of processing resources for acoustic analysis methods. The method reduces the required length of cross-correlation signal windows by providing initial proximity estimates, thereby decreasing processing time while maintaining detection accuracy. The combination of network identification data with acoustic analysis enables more precise localization of audio devices within the physical environment through multi-modal proximity determination.

Further, optionally, determining whether playback of the first audio signal through the second audio device from the at least two audio devices would create the audio interference condition for the first user, further comprises:
determining whether users of the first audio device and the second audio device are within acoustic range of each other based on the detected overlapping audio patterns in the captured audio signals; and
when the users are determined to be within the acoustic range, confirming detection of the audio interference condition between direct acoustic transmission of the first audio signal and electronic playback of the first audio signal.

Herein, the method implements a two-stage verification process to identify potential interference conditions. First, the acoustic range determination analyses the strength and clarity of overlapping audio patterns to establish whether direct acoustic communication between users is possible. The method then evaluates the temporal relationship between direct acoustic transmission paths and electronic playback paths to identify scenarios where delayed electronic playback could interfere with direct acoustic reception.

The technical effect of determining whether users are within acoustic range of each other based on detected overlapping patterns enables validation of potential interference conditions. The distinction between direct acoustic transmission and electronic playback paths allows the method to identify scenarios where interference mitigation is necessary.

Specifically, the method implements a multi-factor analysis framework to validate audio interference conditions between audio devices. The framework processes ambient noise levels and other relevant acoustic characteristics within the physical environment to establish accurate interference prediction models. These models account for variations in speech perception and acoustic masking effects based on the spatial configuration of audio devices and users. The said threshold values for interference detection are dynamically adjusted based on environmental acoustic properties and user preferences to ensure interference condition detection across different usage scenarios.

Optionally, modifying the one or more audio playback parameters comprises at least one of:
muting playback of the first audio signal through the second audio device;
reducing a volume of the playback through the second audio device; or adjusting a delay of the playback through the second audio device.

The method employs an adaptive approach to audio parameter modification based on the specific interference conditions detected. When users are in very close proximity where direct acoustic communication is clear, the method may implement complete muting of electronic playback to avoid any interference. In scenarios with moderate proximity, the method can apply graduated volume reduction that scales with distance between users. Additionally, the method can adjust playback timing to synchronize electronic playback with direct acoustic transmission, minimizing perceptual disruption when complete muting or volume reduction is not necessary. In some examples, the method may involve increasing volume for masking purposes. Generally for present scenarios where time-synchronized playback is implemented, the method involves adjusting gain levels to create a masking effect, thereby improving speech intelligibility through controlled acoustic masking.

The technical effect of implementing specific audio parameter modifications including muting, volume reduction, or delay adjustment enables targeted mitigation of different interference scenarios. The availability of multiple modification options allows the method to select appropriate mitigation strategies based on interference conditions.

In particular, the modification of audio playback parameters follows a structured decision process based on interference severity levels. For high interference conditions where direct acoustic speech is highly intelligible, the method implements immediate playback muting with gradual fade-out to prevent abrupt transitions. In low interference scenarios, the method calculates optimal volume reduction levels that maintain audio intelligibility while minimizing interference effects. The delay adjustment process involves computing propagation delays for direct acoustic paths and applying corresponding electronic delay compensation to achieve temporal alignment between acoustic and electronic signal paths. The method involves continuously monitoring the effectiveness of parameter modifications and adjusts the modification techniques based on changes in acoustic conditions or user positions. The method continuously monitors the effectiveness of parameter modifications and adjusts the modification techniques based on changes in acoustic conditions or user positions.

Optionally, modifying the one or more audio playback parameters further comprises gradually adjusting a volume level based on the determined proximity between the first audio device and the second audio device. Herein, the method implements a distance-based gain control mechanism that continuously adjusts audio playback levels according to spatial separation between audio devices. The gain control mechanism establishes multiple proximity zones with corresponding gain adjustment thresholds, wherein the gain adjustments become more pronounced as the distance between audio devices decreases. The method computes gain adjustment curves that ensure smooth transitions between different proximity zones, preventing abrupt volume changes that could disrupt user experience. The method also considers the cumulative effect of multiple audio devices in close proximity, adjusting individual device gain levels to maintain acceptable overall sound pressure levels in the physical environment. These gain adjustments are synchronized across all affected audio devices to maintain consistent acoustic balance throughout the physical environment.

The technical effect of gradually adjusting volume levels based on determined proximity enables smooth transitions in audio playback as spatial relationships between devices change. The gradual adjustment prevents abrupt changes in audio levels that could disrupt communication flow.

Optionally, the method further comprises:
receiving audio from a remote participant not present in the physical environment;
determining that audio from the remote participant needs to be played to the at least two audio devices within the audio interference range; and
synchronizing playback of the remote participant audio across the at least two audio devices.

For this purpose, the method may implement a centralized audio distribution mechanism for handling remote participant audio signals that ensures coordinated playback across multiple audio devices. The distribution mechanism analyses network conditions and device capabilities to establish optimal routing paths for the remote audio signals. Upon receiving remote participant audio, the method evaluates the spatial configuration of local audio devices to determine which devices require synchronized playback. The synchronization process accounts for various sources of latency including network transmission delays, audio processing delays, and acoustic propagation times between devices.

The technical effect of synchronizing remote participant audio playback across multiple devices prevents formation of echo effects in multi-user scenarios. The synchronized playback maintains clear audio when remote participant audio may need to be played through a local speaker.

The synchronization mechanism may employ a buffering system to manage timing variations in audio signal delivery across different audio devices. The method establishes a common time reference across all participating audio devices using network time synchronization protocols. Buffer lengths at each audio device are dynamically adjusted based on measured network jitter and processing latency variations. The method implements predictive buffering algorithms that anticipate potential timing variations and adjust playback scheduling accordingly. These synchronization mechanisms ensure that audio from the remote participant is delivered synchronously across all audio devices in the physical environment, to prevent echoes.

Optionally, synchronizing the playback comprises:
calculating respective time delays for audio transmission to each of the at least two audio devices;
determining respective audio processing latencies for each of the at least two audio devices; and
adjusting playback timing at each of the at least two audio devices based on the calculated respective time delays and the respective audio processing latencies.

For this purpose, the method implements a time synchronization mechanism wherein audio devices share a common time reference base for coordinating audio playback. Time stamps are applied to audio signals at various processing stages to track signal progression through the system. Herein, the internal processing delays within each audio device are assumed to remain constant throughout a communication session as these are typically low compared to other latencies and can be approximated as constant, enabling calculations for delay compensation. The audio processing latencies for each device are measured during system initialization and stored as calibration parameters for the duration of the session. Herein, for instance, network transmission delays are calculated through periodic measurement of round-trip times between devices sharing the common time reference. Audio processing latencies, including analog-to-digital conversion times, digital signal processing delays, and digital-to-analog conversion times, are aggregated into a composite processing delay value for each device. Additionally, acoustic propagation delays between devices are calculated based on the determined proximity and known speed of sound in the physical environment. The method applies these calculated delays to adjust the playback timing of audio signals, ensuring synchronized output across all participating devices.

The technical effect of calculating and compensating for time delays and processing latencies enables precise synchronization of audio playback across multiple devices. The delay management ensures that audio signals remain temporally aligned even if there are variations in signal paths and processing times.

Optionally, the method comprises:
detecting presence of a speaker system in the physical environment; and
when the speaker system is detected, redirecting the audio from the remote participant to the speaker system instead of the at least two audio devices.

Herein, the “speaker system” refers to audio output devices installed within the physical environment, such as conference room speakers, telecommunication speakerphones, standalone audio speakers, or integrated room audio systems. The method monitors the physical environment for presence of available speaker systems using device discovery protocols, network connection status, and the like. Upon detection of the speaker system, the method evaluates whether to redirect remote participant audio based on configuration parameters of the detected speaker system and current communication requirements. The redirection process involves routing remote participant audio playback from individual audio devices to the detected speaker system. The method adjusts audio signal parameters including playback volume based on characteristics of the speaker system. When multiple speaker systems are available, the method selects an appropriate speaker system based on factors such as proximity to users and audio playback capabilities. The method maintains capability to revert audio playback to individual audio devices when speaker system becomes unavailable or when communication requirements change.

The technical effect of redirecting audio of the remote participant to local speaker systems provides centralized audio delivery when such local speaker is available. The routing capability enables optimal use of available local speaker while maintaining interference management. Optionally, the audio devices are head-mounted devices, and the method further comprises:
receiving video data from cameras of the at least two head-mounted devices; and
analysing the video data to validate that the at least two head-mounted devices are within the audio interference range.

For purposes of the present disclosure, the term “head-mounted devices” refers to wearable audio devices that include both audio and video capabilities. Head-mounted devices may be implemented as virtual reality headsets that provide complete visual immersion in computer-generated environments, augmented reality headsets that overlay digital content onto views of the physical environment, or mixed reality headsets that enable interaction with both physical and digital elements. The head-mounted devices incorporate different types of audio output systems including open-ear speakers that allow external sound transmission, closed-back headphones that provide acoustic isolation, or active noise cancellation headphones that electronically reduce external sound transmission.

The technical effect of using video data for proximity validation provides additional confirmation of spatial relationships between audio devices. The combination of visual and acoustic proximity detection enables better interference management.

The method utilizes integrated cameras in the head-mounted devices to capture video data of the physical environment. The cameras may include outward-facing cameras that capture the surrounding environment, eye-tracking cameras that monitor user gaze direction, or depth-sensing cameras that generate three-dimensional representations of the physical space. Video data from these cameras undergoes real-time processing to extract spatial information about relative positions of head-mounted devices. The method applies computer vision algorithms to detect and track visual markers, environmental features, or other head-mounted devices within the captured video frames. This visual analysis helps to determine and/or validate proximity between head-mounted devices, in addition to acoustic-based detection methods as discussed in the preceding paragraphs. Specifically, herein, the video-based validation process implements multiple analysis techniques for proximity detection. The method processes video frames to identify distinctive visual features that indicate presence of other head-mounted devices within the field of view. Depth information from stereo cameras or dedicated depth sensors enables calculation of precise distances between head-mounted devices when direct line of sight exists. The method may also correlate visual proximity data with acoustic interference measurements for device proximity determinations. When head-mounted devices are confirmed to be within visual range, the method adjusts audio interference mitigation parameters based on the proximity information.

Optionally, the method further comprises:
detecting speech onset using video data from the at least two head-mounted devices; and
using the detected speech onset as a trigger to initiate analysis of the captured audio signals.

Herein, the detection of speech onset may involve processing video data to identify visual indicators of speech activity such as lip movements, jaw motion, and similar patterns. Specifically, the speech onset detection process utilizes computer vision and classification algorithms to process said visual parameters that distinguish speech-related movements from other facial expressions or movements. When speech onset is detected through video analysis, the method activates detailed processing of acoustic signals to evaluate potential interference conditions between audio devices. By using this technique, the method reduces computational requirements for audio signal analysis by limiting detailed acoustic processing to time periods when speech activity is visually confirmed.

The technical effect of using video-based speech onset detection enables reduction in computational requirements for audio signal analysis. The detection of visual speech allows the method to selectively activate detailed acoustic analysis only when speech activity is likely, thereby optimizing processing resource utilization.

The present method for managing audio interference between head-mounted devices detects and mitigates audio interference within virtual reality, augmented reality, and mixed reality environments. The head-mounted devices may incorporate open-ear speakers or closed-back headphones, along with integrated microphones for audio capture and cameras for video monitoring. When multiple head-mounted devices operate within a physical environment, the method involves continuously monitoring both acoustic streams and visual data to identify potential interference conditions. The audio sensors of the head-mounted devices capture direct acoustic speech, ambient sounds, and audio playback signals, while the integrated cameras capture video data of the surrounding environment and user facial movements. The method processes these data streams to establish spatial relationships between head-mounted devices and detect conditions where audio interference may occur.

The method adapts to different configurations of head-mounted devices based on audio output types. For head-mounted devices using open-ear speakers, the method measures Sound Pressure Level of direct acoustic speech using the integrated microphones and calculates expected audio interference based on speaker configurations and spatial positioning. When head-mounted devices use closed-back headphones, the method applies different acoustic models that account for reduced external sound transmission. The video data from head-mounted device cameras provides additional validation of device proximity and enables early detection of potential interference conditions through visual detection of speech onset. The method implements synchronized playback mechanisms across multiple head-mounted devices when remote participant audio needs to be delivered, utilizing shared time references and accounting for network transmission delays and internal processing latencies of each head-mounted device.

The method implements interference mitigation techniques specifically adapted for head-mounted device operations in AR/VR/MR environments. When interference conditions are detected between head-mounted devices, the method involves modifying audio playback parameters based on the specific requirements of virtual or augmented reality applications. The modifications include adjustment of audio rendering parameters, synchronization of virtual audio sources with physical positioning, and coordination of audio playback between multiple head-mounted devices. Thereby, the method enables head-mounted devices to operate effectively in proximity by managing audio interference conditions.

In general, the present method implements specific mitigations for delayed auditory feedback (DAF) effects that occur in multi-user scenarios. When multiple audio devices operate within the physical environment, a user may hear the same audio signal through multiple paths, like direct acoustic transmission and delayed electronic playback through nearby audio devices. The method involves measuring the temporal difference between direct acoustic reception and electronic playback paths to identify conditions where delayed auditory feedback could impact speech production. The method further involves applying different mitigation techniques based on measured delay intervals, as delayed auditory feedback effects become more pronounced at specific delay ranges. These mitigation techniques prevent speech disruption effects such as reduced speaking rate and stuttering that commonly occur when users hear delayed versions of their own speech.

The present method adapts interference management techniques based on specific audio device configurations present in the physical environment. For audio devices using open-ear speakers, the method implements more aggressive interference mitigation due to increased acoustic leakage between devices. The method measures acoustic isolation characteristics of different audio device types and adjusts interference detection thresholds accordingly. When closed-back headphones or active noise cancellation headphones are present, the method implements modified threshold values that account for increased acoustic isolation. The method maintains separate processing parameters for different combinations of audio device types operating within the same physical environment.

It may be appreciated that the present method scales to scenarios involving more than two audio devices within the physical environment through implementation of multi-device coordination protocols. In such scenarios, the method may involve creating a spatial map of all audio devices operating within the physical environment and tracks their relative positions and interference relationships. For each audio device, the method maintains separate interference detection and mitigation parameters with respect to all other devices in range. The coordination protocols ensure that interference mitigation actions applied between any pair of devices do not create new interference conditions with other nearby devices.

The present disclosure also relates to the system as described above. Various embodiments and variants disclosed above, with respect to the aforementioned method, apply mutatis mutandis to the system of the present disclosure.

The system for managing audio interference implements a hardware architecture specifically designed for real-time audio interference detection and mitigation. The first audio device and the second audio device each incorporate dedicated audio sensors implemented as multi-element microphone arrays with integrated analog-to-digital converters for high-quality audio capture. The processing unit comprises a digital signal processor with dedicated hardware modules for audio signal analysis, feature extraction, and pattern matching operations. The processing unit implements parallel processing techniques for simultaneous analysis of audio streams from multiple audio devices, with dedicated memory buffers for temporary storage of audio data during analysis. The communication interfaces between the audio devices and the processing unit utilize data protocols to ensure minimal latency in audio signal transmission and processing. The processing unit may also incorporate hardware-accelerated modules for cross-correlation computation and audio parameter modification, enabling real-time adjustment of playback parameters when interference conditions are detected.

Optionally, the system further comprises:
a speaker system communicatively coupled to the processing unit;
wherein the processing unit is further configured to:
receive audio from a remote participant not present in the physical environment;
detect presence of the speaker system in the physical environment; and
when the speaker system is detected, redirect the audio from the remote participant to the speaker system instead of the first audio device and the second audio device.

The system implements an audio routing architecture in which the speaker system is communicatively coupled to the processing unit through digital audio interfaces. The speaker system includes signal processing capabilities, with the processing unit maintaining control over audio routing and playback parameters. The processing unit monitors connection status of the speaker system through periodic status checks and implements automatic mechanisms to maintain audio delivery through audio devices when speaker system connectivity is lost.

The technical effect of incorporating a speaker system with the processing unit enables redirection of remote user audio. The automatic detection and utilization of available speaker systems allows the system to optimize audio delivery based on available infrastructure.

Optionally, in the system, the audio devices are head-mounted devices, wherein:
the first head-mounted device comprises a first camera;
the second head-mounted device comprises a second camera; and
the processing unit is further configured to:
receive video data from the first camera and the second camera;
analyse the video data to validate that the first head-mounted device and the second head-mounted device are within the audio interference range.

The system employs integrated cameras within the head-mounted devices that capture high-resolution video data of the physical environment. The cameras incorporate image sensors with wide field-of-view optics to maximize coverage of the surrounding space. The processing unit implements image processing modules for real-time analysis of video streams from multiple head-mounted devices. The system utilizes dedicated video data transmission channels between the head-mounted devices and the processing unit to ensure consistent video quality for proximity validation.

The technical effect of integrating cameras within head-mounted devices enables video-based validation of proximity between devices. The combination of audio sensors and cameras helps to establish accurate spatial relationships between head-mounted devices, enhancing reliability of interference management.

The video processing capabilities of the system enable real-time tracking of relative positions between head-mounted devices through computer vision algorithms implemented in hardware. The processing unit incorporates parallel processing elements for simultaneous analysis of multiple video streams, with dedicated memory regions for frame buffering and feature extraction. The system maintains synchronized timing between video frames and audio signals through hardware timestamp mechanisms, enabling accurate correlation of visual and acoustic proximity data. The video analysis results are integrated with audio interference detection for detection of interference condition.

The method and the system of the present disclosure provide a solution to managing audio interference between multiple audio devices operating within a physical environment by implementing automated detection and mitigation of interference conditions through analysis of overlapping audio patterns and modification of audio playback parameters. The method and the system enable effective audio communication in scenarios where multiple users employ audio devices with varying acoustic characteristics, particularly addressing challenges posed by open-ear speaker designs in head-mounted devices. The combination of audio pattern analysis and proximity detection provides accurate identification of interference conditions without requiring manual configuration or user intervention. The method and the system implement dynamic adjustment of audio playback parameters based on actual acoustic conditions within the physical environment, ensuring optimal audio delivery across multiple audio devices. The automatic detection and mitigation capabilities maintain natural communication flow between users while preventing delayed auditory feedback effects that can disrupt speech production.

### DETAILED DESCRIPTION OF THE DRAWINGS

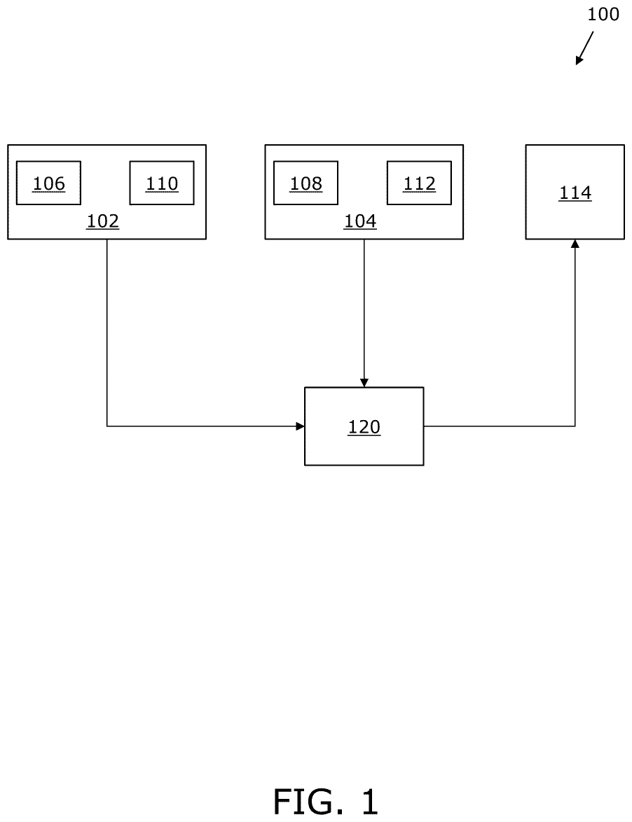

Referring to FIG. 1, illustrated is a block diagram of a system 100 for managing audio interference between audio devices operating within a physical environment, in accordance with an embodiment of the present disclosure. The system 100 comprises a first audio device 102 having a first audio sensor 106 and a second audio device 104 having a second audio sensor 108. The first audio device 102 further comprises a first camera 110 and the second audio device 104 further comprises a second camera 112, wherein the cameras are configured to capture video data from the physical environment.

The system 100 comprises a processing unit 120 communicatively coupled to the first audio device 102 and the second audio device 104. The processing unit 120 is configured to receive respective audio signals captured from the physical environment using the first and second audio sensors 106, 108; analyse the captured audio signals to determine whether the first audio device 102 and the second audio device 104 are within an audio interference range by detecting overlapping audio patterns in the captured audio signals and determining proximity between the first audio device 102 and the second audio device 104 based on the detected overlapping audio patterns; detect a first audio signal from a first user associated with the first audio device 102 when determined to be within the audio interference range; determine whether playback of the first audio signal through the second audio device 104 would create an audio interference condition for the first user based on the determined proximity; and when it is determined that the playback would create the audio interference condition, modify one or more audio playback parameters of the second audio device 104 to mitigate the audio interference condition.

The system 100 further comprises a speaker system 114 communicatively coupled to the processing unit 120. The processing unit 120 is further configured to receive audio from a remote participant not present in the physical environment, detect presence of the speaker system 114 in the physical environment, and when the speaker system 114 is detected, redirect the audio from the remote participant to the speaker system 114 instead of the first audio device 102 and the second audio device 104. The processing unit 120 is additionally configured to receive video data from the first camera 110 and the second camera 112 and analyse the video data to validate that the first audio device 102 and the second audio device 104 are within the audio interference range.

FIG. 1 is merely an example, which should not unduly limit the scope of the claims herein. A person skilled in the art will recognize many variations, alternatives, and modifications of embodiments of the present disclosure.

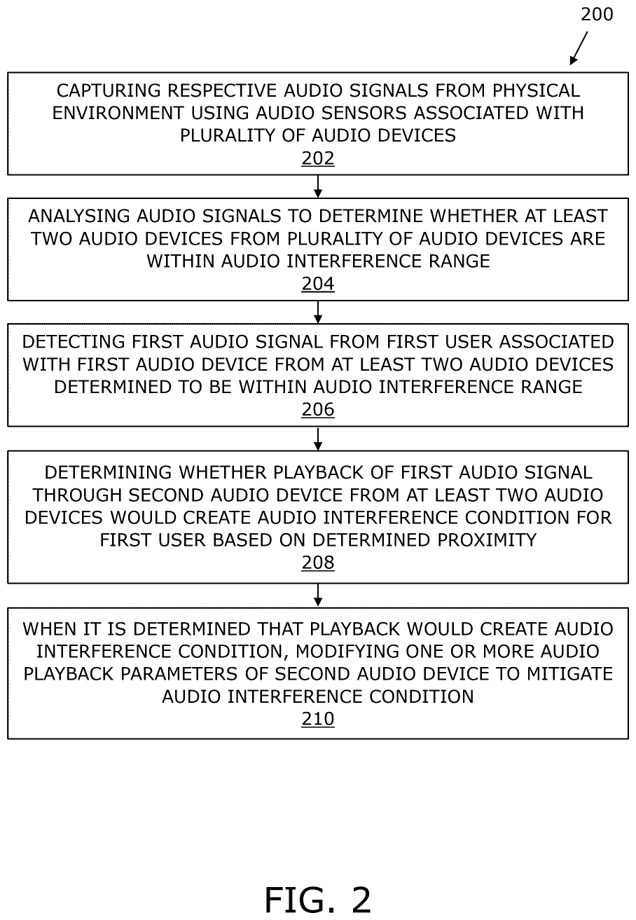

Referring to FIG. 2, illustrated is a flowchart of steps involved in a method 200 for managing audio interference between audio devices operating within a physical environment, in accordance with an embodiment of the present disclosure. At step 202, the method 200 includes capturing respective audio signals from the physical environment using audio sensors associated with a plurality of audio devices. The audio signals are captured using audio sensors such as the first audio sensor 106 of the first audio device 102 and the second audio sensor 108 of the second audio device 104. At step 204, the method 200 includes analysing the audio signals to determine whether at least two audio devices from the plurality of audio devices are within an audio interference range. This step comprises detecting overlapping audio patterns in the captured audio signals and determining proximity between the at least two audio devices based on the detected overlapping audio patterns. The processing unit 120 performs this analysis using the audio signals received from the first audio device 102 and the second audio device 104. At step 206, the method 200 includes detecting a first audio signal from a first user associated with a first audio device from the at least two audio devices determined to be within the audio interference range. At step 208, the method 200 includes determining whether playback of the first audio signal through a second audio device from the at least two audio devices would create an audio interference condition for the first user based on the determined proximity. When the audio interference condition is determined to exist, the method 200 proceeds to step 210, which includes modifying one or more audio playback parameters of the second audio device to mitigate the audio interference condition. The processing unit 120 implements these audio parameter modifications through control signals sent to the affected audio devices. The modifications may include adjusting playback through the second audio device 104 or redirecting audio to the speaker system 114 when available within the physical environment.

The aforementioned steps are only illustrative, and other alternatives can also be provided where one or more steps are added, one or more steps are removed, or one or more steps are provided in a different sequence without departing from the scope of the claims herein.

1. A method for managing audio interference between audio devices operating within a physical environment, the method comprising:
capturing respective audio signals from the physical environment using audio sensors associated with a plurality of audio devices;
analysing the audio signals to determine whether at least two audio devices from the plurality of audio devices are within an audio interference range by:
detecting overlapping audio patterns in the captured audio signals, and
determining proximity between the at least two audio devices based on the detected overlapping audio patterns;
detecting a first audio signal from a first user associated with a first audio device from the at least two audio devices determined to be within the audio interference range;
determining whether playback of the first audio signal through a second audio device from the at least two audio devices would create an audio interference condition for the first user based on the determined proximity; and
when it is determined that the playback would create the audio interference condition, modifying one or more audio playback parameters of the second audio device to mitigate the audio interference condition.

2. The method of claim 1, wherein analysing the captured audio signals to determine whether the at least two audio devices are within the audio interference range further comprises:
computing a cross-correlation between the audio signals captured by the at least two audio devices; and
determining that the at least two audio devices are within the audio interference range when the computed cross-correlation exceeds a predetermined threshold.

3. The method of claim 1, wherein analysing the captured audio signals to determine whether at least two audio devices are within the audio interference range further comprises:
detecting ambient audio patterns in the captured audio signals; and
comparing the detected ambient audio patterns to determine whether the at least two audio devices are within the audio interference range.

4. The method of claim 1, wherein determining whether the at least two audio devices are within the audio interference range further comprises:
obtaining network identification information from each audio device; and
analysing the network identification information to determine proximity between the at least two audio devices.

5. The method of claim 1, wherein determining whether playback of the first audio signal through the second audio device from the at least two audio devices would create the audio interference condition for the first user, further comprises:
determining whether users of the first audio device and the second audio device are within acoustic range of each other based on the detected overlapping audio patterns in the captured audio signals; and
when the users are determined to be within the acoustic range, confirming detection of the audio interference condition between direct acoustic transmission of the first audio signal and electronic playback of the first audio signal.

6. The method of claim 1, wherein modifying the one or more audio playback parameters comprises at least one of:
muting playback of the first audio signal through the second audio device;
reducing a volume of the playback through the second audio device; or
adjusting a delay of the playback through the second audio device.

7. The method of claim 1, wherein modifying the one or more audio playback parameters further comprises gradually adjusting a volume level based on the determined proximity between the first audio device and the second audio device.

8. The method of claim 1, further comprising:
receiving audio from a remote participant not present in the physical environment;
determining that audio from the remote participant needs to be played to the at least two audio devices within the audio interference range; and
synchronizing playback of the remote participant audio across the at least two audio devices.

9. The method of claim 8, wherein synchronizing the playback comprises:
calculating respective time delays for audio transmission to each of the at least two audio devices;
determining respective audio processing latencies for each of the at least two audio devices; and
adjusting playback timing at each of the at least two audio devices based on the calculated respective time delays and the respective audio processing latencies.

10. The method of claim 8, further comprising:
detecting presence of a speaker system in the physical environment; and
when the speaker system is detected, redirecting the audio from the remote participant to the speaker system instead of the at least two audio devices.

11. The method of claim 1, wherein the audio devices are head-mounted devices, and wherein the method further comprises:
receiving video data from cameras of the at least two head-mounted devices; and
analysing the video data to validate that the at least two head-mounted devices are within the audio interference range.

12. The method of claim 1, further comprising:
detecting speech onset using video data from the at least two head-mounted devices; and
using the detected speech onset as a trigger to initiate analysis of the captured audio signals.

13. A system for managing audio interference between audio devices operating within a physical environment, the system comprising:
a first audio device having a first audio sensor;
a second audio device having a second audio sensor;
a processing unit communicatively coupled to the first audio device and the second audio device, wherein the processing unit is configured to:
receive respective audio signals captured from the physical environment using the first and second audio sensors;
analyse the captured audio signals to determine whether the first audio device and the second audio device are within an audio interference range by:
detecting overlapping audio patterns in the captured audio signals, and
determining proximity between the first audio device and the second audio device based on the detected overlapping audio patterns;
detect a first audio signal from a first user associated with the first audio device when determined to be within the audio interference range;
determine whether playback of the first audio signal through the second audio device would create an audio interference condition for the first user based on the determined proximity; and
when it is determined that the playback would create the audio interference condition, modify one or more audio playback parameters of the second audio device to mitigate the audio interference condition.

14. The system of claim 13, further comprising:
a speaker system communicatively coupled to the processing unit;
wherein the processing unit is further configured to:
receive audio from a remote participant not present in the physical environment;
detect presence of the speaker system in the physical environment; and
when the speaker system is detected, redirect the audio from the remote participant to the speaker system instead of the first audio device and the second audio device.

15. The system of claim 13, wherein the audio devices are head-mounted devices, and wherein:
the first head-mounted device comprises a first camera;
the second head-mounted device comprises a second camera; and
the processing unit is further configured to:
receive video data from the first camera and the second camera;
analyse the video data to validate that the first head-mounted device and the second head-mounted device are within the audio interference range.
